(19) United States
(12) Patent Application Publication
(10) Pub. No.: US 2008/0115895 A1
(43) Pub. Date: May 22, 2008

(54) Safety window blind cord connector

(76) Inventor: Cheng-Hsiung Su, Taipei (TW)

Correspondence Address: BACON & THOMAS, PLLC, 625 SLATERS LANE, FOURTH FLOOR, ALEXANDRIA, VA, 22314, US

(21) Appl. No.: 11/790,322

(22) Filed: Apr. 25, 2007

(30) Foreign Application Priority Data
Nov. 16, 2006 (CN) 200620148900.1

(51) Int. Cl. E06B 9/00

(52) U.S. Cl. 160/178.1 R

(57) ABSTRACT

A safety window blind lift cord connector includes a mounting seat and a lift cord connecting ring. The lift cord connecting ring is provided at a lower portion with a lift cord fastening recess, the mounting seat has a retaining plate connected thereto to form a retaining space between them; and the lift cord connecting ring has a ring-shaped upper portion defining a middle mounting hole and having a gap formed at a top of the mounting hole. The lift cord connecting ring may be detachably connected to the mounting seat at the retaining space with the retaining plate outward extended through the middle mounting hole of the lift cord connecting ring. When a window blind lift cord fastened to the lift cord fastening recess is downward pulled with an excessive force, the lift cord connecting ring is automatically detached from the mounting seat via the gap, ensuring that the window blind lift cord would not injure any small child.

### FIELD OF THE INVENTION

The present invention relates to a safety window blind lift cord connector.

### BACKGROUND OF THE INVENTION

While a window blind, particularly a roll up blind, brings a beautiful scene in people's living space, the lift cord of the window blind also forms a potential threat to small family members. Generally, the window blind lift cord has an end fixed to a lift cord lock in a head box of the window blind. That is, the lift cord is fixedly connected to the head box to hang therefrom. A curious small child might use the hanging lift cord as a swing to play while no adults are home. It is very possible the lift cord is unexpectedly wound around the small child's neck to badly injure the child. To protect the small child against any danger possibly caused by the window blind lift cord, adults often try to position the lift cord at some place unreachable by the small child. However, this does not thoroughly solve the problem of the potential thread of the lift cord to small family members.

### SUMMARY OF THE INVENTION

A primary object of the present invention is to provide a safety window blind lift cord connector that ensures a window blind lift cord connected thereto is safe for use and would not injure small child.

To achieve the above and other objects, the safety window blind lift cord connector of the present invention includes a mounting seat and a lift cord connecting ring. The lift cord connecting ring is provided at a lower portion with a lift cord fastening recess. The mounting seat has a retaining plate connected thereto, such that a retaining space is formed between an end of the mounting seat and the retaining plate. The lift cord connecting ring has a substantially ring-shaped upper portion defining a middle mounting hole. A gap is formed on the ring-shaped upper portion of the lift cord connecting ring to locate at a top of the mounting hole. The lift cord connecting ring may be detachably connected to the mounting seat via the gap to locate in the retaining space with the retaining plate outward extended through the mounting hole.

To enable convenient installation of the safety window blind lift cord connector, the mounting seat is an L-shaped member having a horizontal plate and a vertical plate that are perpendicular to each other. The retaining plate is connected to an outer surface of the vertical plate. The horizontal plate defines a middle U-shaped opening.

When a window blind lift cord fastened to the lift cord fastening recess is downward pulled with an excessive force, the lift cord connecting ring is detached from the mounting seat via the gap to ensure that the window blind lift cord is safe for use and would not injure small child.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a safety window blind lift cord connector; and

FIG. 2 is an assembled view of FIG. 1.

### DETAILED DESCRIPTION OF THE PREFERRED EMBODIMENTS

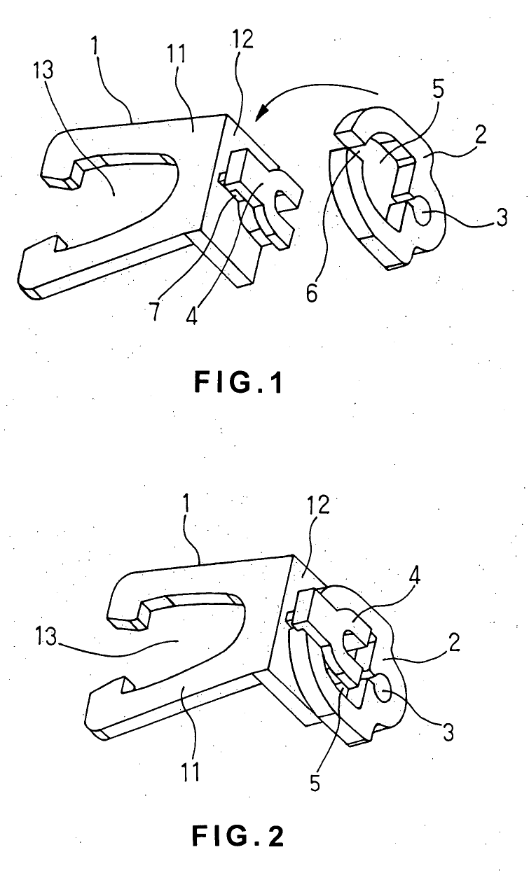

Please refer to FIGS. 1 and 2 that are exploded and assembled perspective views, respectively, of a safety window blind lift cord connector according to a preferred embodiment of the present invention. As shown, the safety window blind lift cord connector of the present invention includes a mounting seat 1 and a lift cord connecting ring 2. The lift cord connecting ring 2 is provided at a lower portion with a lift cord fastening recess 3. The mounting seat 1 has a retaining plate 4 connected thereto, such that a retaining space 7 is formed between an end of the mounting seat 1 and the retaining plate 4. The lift cord connecting ring 2 has a substantially ring-shaped upper portion defining a middle opening to serve as a mounting hole 5. A gap 6 is formed on the ring-shaped upper portion of the lift cord connecting ring 2 to locate at a top of the mounting hole 5. The lift cord connecting ring 2 may be connected to the mounting seat 1 to locate in the retaining space 7 with the retaining plate 4 outward extended through the mounting hole 5.

To enable convenient installation of the safety window blind lift cord connector of the present invention, the mounting seat 1 is an L-shaped member having a horizontal plate 11 and a vertical plate 12 that are perpendicular to each other. The retaining plate 4 is connected to an outer surface of the vertical plate 12. The horizontal plate 11 defines a middle U-shaped opening 13.

The lift cord connecting ring 2 is detachably connected to the mounting seat 1 via the gap 6 on the lift cord connecting ring 2. When a window blind lift cord (not shown) being fastened at an upper end to the lift cord fastening recess 3 is downward pulled with an excessive force, the lift cord connecting ring 2 is automatically detached from the mounting seat 1 via the gap 6 to ensure that the window blind lift cord is safe for use and would not injure any small child.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A safety window blind lift cord connector, comprising a mounting seat and a lift cord connecting ring; the lift cord connecting ring being provided at a lower portion with a lift cord fastening recess; the mounting seat having a retaining plate connected thereto to form a retaining space between the mounting seat and the retaining plate; the lift cord connecting ring having a ring-shaped upper portion defining a middle opening to serve as a mounting hole and having a gap formed at a top of the mounting hole; such that the lift cord connecting ring may be detachably connected to the mounting seat at the retaining space with the retaining plate outward extended through the middle mounting hole of the lift cord connecting ring.

2. The safety window blind lift cord connector as claimed in claim 1, wherein the mounting seat is an L-shaped member including a horizontal plate and a vertical plate that are perpendicular to each other, and the retaining plate being connected to an outer surface of the vertical plate.

3. The safety window blind lift cord connector as claimed in claim 2, wherein the horizontal plate of the mounting seat defines a middle U-shaped opening.
